(19) United States
(12) Patent Application Publication
(10) Pub. No.: US 2017/0056724 A1
(43) Pub. Date: Mar. 2, 2017

(54) CLIMBING PERFORMANCE MEASUREMENT AND STORAGE DEVICE

(71) Applicant: MbientLab Inc., San Francisco, CA (US)

(72) Inventor: Matthew Baker, San Francisco, CA (US)

(21) Appl. No.: 15/137,220

(22) Filed: Apr. 25, 2016

Related U.S. Application Data
(60) Provisional application No. 62/209,087, filed on Aug. 24, 2015.

(51) Int. Cl. A63B 24/00; A63B 29/00; G09B 19/00

(52) U.S. Cl. CPC A63B 24/0062; G09B 19/0038; A63B 29/00

(57) ABSTRACT

Components, methods, and apparatuses are provided that may be comprise a climbing performance measurement device to measure and/or report climbing-related parameters. In embodiments, the climbing performance measurement device may be worn at a climber's midsection and may include one or more of an accelerometer, a magnetometer, and altimeter, a vibration motor, a gyroscope, one or more computer processors. A climbing performance measurement device may cooperate with other devices, such as a wrist-worn computer or a chest strap to monitor and/or report a climber's heart rate.

### CROSS REFERENCE TO RELATED APPLICATION

The present application claims priority to U.S. provisional application No. 62/209,087 entitled “Method and Apparatus to Measure Technical Rock, Ice, and Mountain Climbing Performance ” filed on Aug. 24, 2015.

### BACKGROUND

1. Field

The subject matter disclosed herein relates to measurement of a climber's performance while climbing an obstacle, such as may be encountered during technical rock climbing, ice climbing, or mountain climbing.

2. Information

Currently, a wide variety of tools and equipment are available to aid technical climbers, ice climbers, mountain climbers, and other types of climbing enthusiasts. Such items include protective clothing, such as gloves, helmets, boots, and so forth, as well as climbing ropes, harnesses, crampons, carabiners, etc. This equipment may increase a climber's performance, enhance a climber's enjoyment, and provide some level of protection should an unplanned climbing event or climbing mishap occur.

In addition to specialized clothing and mechanical climbing gear, a climbing enthusiast may attempt to utilize electronic devices, such as a global positioning system (GPS) receivers, GPS-equipped smartphones, GPS-enabled wristwatches, for example. Such equipment may provide routing instructions, navigation, and other map-related capabilities.

However, such equipment may not always operate in a manner that is convenient for use in climbing environments. For example, a climber attempting to use a GPS device to determine the vertical distance climbed during a climbing outing may find that acquiring GPS signals, while a climber is in close proximity with a steep cliff, for example, may be problematic or even impossible due to signal blockage from the cliff. In other instances, a climber attempting to make use of a wristwatch-enabled GPS device may find that a wrist-mounted device can bring about safety concerns as the device may become caught, for example, or entangled in one or more articles of clothing and/or climbing equipment. Further, a climber may wish to record and store a variety of climbing-related parameters, which is simply not possible with conventional devices, such as GPS-enabled smartphones and/or wristwatches.

### SUMMARY

In an embodiment, an apparatus may comprise an altimeter to measure a vertical distance traversed by a climber, an inclinometer to measure an angle of incline of at least a portion of the climber's body during one or more portions of the climber's traversal of the vertical distance, and a memory to record measurements of the vertical distance and the angle of incline of the at least a portion of the climber's body. An apparatus may further comprise a transmitter to wirelessly communicate measurements of the vertical distance and the angle of incline in a substantially real-time manner. An apparatus may further comprise one or more accelerometers to measure accelerations of the climber's body during the one or more portions of the climber's traversal. An apparatus may further comprise one or more processors to implement an optimization filter, such as a Kalman filter, to determine the vertical distance climbed based, at least in part, on output signals from the altimeter and output signals from the one or more accelerometers. The one or more processors of the apparatus may additionally implement a classifier to determine a skill category based, at least in part, on one or more output signals from the altimeter, one or more output signals from the inclinometer, and one or more output signals from the one or more accelerometers. The one or more processors of the apparatus may additionally operate to provide at least one suggestion, the at least one suggestion to refer to a climbing location or climbing activity based, at least in part, on the climber's skill level estimated by the one or more processors. The one or more processors of the apparatus may additionally operate to provide at least one suggestion of a climbing skill in need of improvement. In an embodiment, a climbing performance monitoring device may include mounting provisions to couple the apparatus to an area proximate with the climber's midsection. Mounting provisions may operate to maintain orientation of the apparatus to correspond with orientation of the climber's waist area of the midsection.

An embodiment may include a storage medium comprising machine-readable instructions stored thereon which are executable by one or more processors of a computer to initiate determination of a vertical distance traversed by a climber, to initiate measurement of an incline of at least a portion of the climber's body during one or more portions of the climber's traversal of the vertical distance climbed, and to initiate storage, in a memory array, of recorded measurements of the vertical distance and angle of incline of the at least a portion of the climber's body. The computer-readable instructions may additionally be executable to initiate recording of output signal traces from one or more three-axis accelerometers. The computer-readable instructions may additionally be executable to initiate optimal filtering of output signal traces from an altimeter combined with the output signal traces of one or more accelerometers to arrive at the vertical distance traversed by the climber. The computer-readable instructions may additionally be executable to initiate recording of output signal traces from a gyroscope, a three-axis accelerometer, a magnetometer, or any combination thereof. The computer-readable instructions may additionally be executable to wirelessly transmit parameters to a centralized receiver based, at least in part, on output signal traces from one or more accelerometers, one or more inclinometers, one or more altimeters, one or more magnetometers, one or more gyroscopes, or any combination thereof. The computer-readable instructions may additionally be executable to initiate providing a suggestion to a climber as to a climbing skill in need of improvement. The computer-readable instructions may additionally be executable to classify a climber's performance based, at least in part, on output signal traces of one or more accelerometers.

In another embodiment, an apparatus may comprise means for measuring vertical distance traversed by climber, means for measuring inclination of at least a portion of the climber's body during one or more portions of the climber's traversal of the vertical distance climbed, and means for recording measurements of the vertical distance and the angle of incline of the at least a portion of the climber's body. In another embodiment, the apparatus may additionally comprise means for reporting output signal traces corresponding to measurements of vertical distance traversed by a climber. In another embodiment, the apparatus may additionally comprise means for classifying a climber's skill level. In another embodiment, the apparatus may additionally comprise means for suggesting an activity to improve a climber's skill level.

It should be understood that the aforementioned implementations are merely example implementations, and that claimed subject matter is not necessarily limited to any particular aspect of these example implementations.

### BRIEF DESCRIPTION OF DRAWINGS

Non-limiting and non-exhaustive aspects are described with reference to the following figures, wherein like reference numerals refer to like parts throughout the various figures.

FIG. 1 shows a climber scaling a rock wall according to an embodiment.

FIG. 2 shows a climbing performance measurement device and an example coordinate system according to an embodiment.

FIG. 3 shows a climbing performance measurement device attached to a climber's midsection according to an embodiment.

FIG. 4 shows a sample accelerometer output signal trace recorded by a climbing performance measurement device worn by a first climber according to an embodiment.

FIG. 5 shows a sample accelerometer output signal trace recorded by a climbing performance measurement device worn by a second climber according to an embodiment.

FIG. 6 shows a schematic diagram of a climbing performance measurement device according to an embodiment.

FIG. 7 shows a simplified plot of parameters recorded from a climbing performance measurement device and climber's potential skill classification according to an embodiment.

FIG. 8 shows an indoor climbing competition along with a leaderboard identifying climbers according to an embodiment.

FIG. 9 shows a climbing performance measurement device forming a part of a distributed computing network according to an embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

Reference throughout this specification to “one example,” “one feature,” “one embodiment,” “an example,” “a feature,” or “an embodiment” means that a particular feature, structure, or characteristic described in connection with the feature, example or embodiment is included in at least one feature, example or embodiment of claimed subject matter. Thus, appearances of the phrase “in one example,” “an example,” “in one feature,” a feature,” “an embodiment,” or “in one embodiment” in various places throughout this specification are not necessarily all referring to the same feature, example, or embodiment. Furthermore, particular features, structures, or characteristics may be combined in one or more examples, features, or embodiments.

As previously alluded to, a variety of specialized clothing and mechanical aids are available to climbing enthusiasts. In addition to these, a mountain climber, ice climber, technical climber, or other type of climbing enthusiast may attempt to utilize one or more electronic devices to permit recording of particular climbing-related parameters during a climbing outing. For example, a climber attempting to improve his or her ability to quickly ascend a rock face, for example, may attempt to utilize a GPS-equipped device to record a vertical distance traversed over a specified period of time. However, a climber in close proximity with a steep canyon wall, for example, may find it difficult or impossible to acquire signals from the requisite number of orbiting navigation satellites. Thus, obtaining a GPS position fix, for example, may represent a challenging task. Additionally, in other instances, a climber operating in an indoor environment, such as at a climbing gym, for example, may find GPS devices altogether unusable. Further, a climber attempting to utilize a GPS-enabled wristwatch, for example, may find that a wrist-mounted device may be prone to interfering with climbing ropes and other climbing gear.

A climbing performance measurement device according to particular embodiments of claimed subject matter may provide a mountain climber, ice climber, technical climber, or other type of climbing enthusiast, with capability to record climbing-related parameters. For example, a climbing performance measurement device may comprise an altimeter, which may provide relatively precise measurements of vertical ascent without utilizing, for example, signals from orbiting GPS satellites. In certain embodiments, by avoiding a need for acquiring GPS signals from orbiting satellites, a need for complex signal processing may be reduced, which may bring about savings in power consumption, which may extend battery life of a climbing performance measurement device.

In particular embodiments, accuracy of output signals representing altitude measured by an altimeter, for example, may be optimized using an optimization filter, such as a linear quadratic estimation filter, a Kalman filter, and/or a particle filter, just to name a few examples. Such optimization of output signals representing altitude measured by an altimeter may be made possible using output signals from one or more three-axis accelerometers, for example. In embodiments, optimized output signals from an altimeter and one or more three-axis accelerometers may be stored in a memory device accessed by a processor of a climbing performance measurement device. In particular embodiments, a memory utilized by a performance measurement device may comprise memory sufficient to record climbing parameters for a multi-day mountain adventure, for example.

In embodiments, a climbing performance measurement device may be removably secured to a climber's midsection, such as for example, removably secured to a climbers belt near the base of the climber's spine. Such a location may permit recording of climbing-related parameters without interfering with a climber's hand and/or arm movements during climbing. In addition, mounting a climbing performance measurement device near a climber's midsection may reduce or eliminate measurement of relatively meaningless higher-frequency accelerations responsive to a climber's rapid hand and/or arm movement during climbing activities. Accordingly, output signals from one or more three-axis accelerometers may more accurately represent accelerations experienced by a climber's body during climbing activities.

Further, accurate measurement of acceleration, which may be brought about by attaching a climbing performance measurement device by way of a loop, hook and loop fasteners (such as “Velcro™”), snap fasteners, etc., to an area near a climber's midsection, may provide a capability to assess a climber's performance as a climber becomes fatigued, alarmed, or anxious, for example. In one possible example, many climbers tend to move smoothly during a beginning portion of a climb and to move more erratically using sudden, jerking motions as the climber experiences fatigue. Accordingly, a climbing performance measurement device located near a climber's midsection may accurately measure types of accelerations brought about by such erratic, sudden motions. By studying recorded output signals from a performance measurement device, a climber may be trained to focus on maintaining smooth and contemplated movements at all points during, for example, a difficult and/or a time-consuming climb.

Locating a performance measurement device at or near a climber's midsection may provide an additional benefit of accurately measuring orientation of the climber's body relative to a vertical reference plane, which may coincide with the plane of a steep cliff face, as well as measuring orientation of the climber's body in a lateral plane, such as from side-to-side. Accordingly, measurements of, for example, a climber's body incline towards or away from the plane of a steep cliff face may be faithfully re-created and assessed to establish the climber's true performance parameters. For example, a climber may be trained to pay particular attention to his or her inclination relative to the plane of a steep cliff face, such that minor corrections, of perhaps only a few degrees, for example, to improve the climber's ability to ascend a challenging rock face or cliff, for example. In another example, detecting that a climber's body tends to become oriented or biased in a lateral direction (e.g., to the left or to the right) during a climb may improve the climber's technique in certain situations.

In an embodiment, a climbing performance measurement device may comprise a capability to process output signals from, for example, a variety of motion sensors, such as three-axis accelerometers, gyroscopes, magnetometers, altimeters, etc., which may permit a special-purpose computer processor to “classify” a climber's performance. Thus, for example, a climber who routinely ascends a difficult, steep cliff in a short period of time, while maintaining smooth and deliberate movements at all points during the climb, and while maintaining optimal body inclination relative to the cliff face, for example, may be classified as a “skilled” climber. In another example, a climber who is challenged by more benign climbing environments, requiring extensive rest periods during the climb, and at least occasionally appears to assume apparently awkward body orientations, may be classified by one or more processors as a “novice” climber.

In an embodiment, a climbing performance measurement device may comprise a vibration motor, or other type of user feedback component, to provide various status indications to a climber. For example, a user feedback component may comprise a vibration motor to notify a climber as the climber is nearing the top of a rock face, for example. In another example, a user feedback component comprising a vibration motor may alert a climber each time the climber achieves a 25-meter increment in elevation, a 50-meter increment in elevation, or achieves any other suitable increment in elevation. In another example, a user feedback component comprising a vibration motor may notify a climber of a degradation in the climber's performance. For example, if a classifier indicates that a climber is exhibiting erratic movements, a vibration motor may warn the climber that he or she should exercise an additional level of caution, that the climber should rest, or that the climber should focus on executing more steady and smooth movements. Accordingly, a classifier of a climbing performance measurement device may be capable of classifying, in addition to a climber's skill level, a type of activity being performed, specific discrete movements, a difficulty of a climb for a particular climber, as well as a wide variety of additional inferences based, at least in part, on output signal traces from accelerometers, gyroscopes, magnetometers, imaging sensors, heart rate sensors, and so forth. In another embodiment, a user feedback component may comprise an LED indicator, buzzer, and/or a liquid crystal display, which may operate to provide any type of perceptible feedback such as a vibration, an audible cue (e.g., a buzzer or other type of audio signal), a visible cue (e.g., a flashing light emitting diode), and claimed subject matter is not limited in this respect.

Thus, in embodiments, a climbing performance measurement device may suggest particular practice activities that may benefit climbers having all types of skill classifications. For example, a climber who appears to make sudden, jerking movements during climbing outings may benefit from suggestions to practice moving more fluidly. A climber who appears to require an inordinate number of rest intervals during particular climbs, for example, may be benefit from suggestions to engage in certain types of weightlifting and/or conditioning, so as to increase strength and/or endurance.

A climbing performance measurement device may additionally suggest certain types of climbing outings that could improve a climber's skill, for example. Thus, a climber classified as a “novice” may benefit from suggestions to climb particular named rock formations at a certain location, for example, in the southwest portion of the United States. In other instances, an ice climber classified as a “skilled” climber may benefit from a suggestion to climb a particular ice formation at a particular location in Alaska, United States. In embodiments, such suggestions may be tailored, for example, so as to provide opportunities for climbers to improve particular skills and/or skill sets detected as being in need of improvement by way of a classifying process.

In embodiments, a climbing performance measurement device may include a wireless transceiver, which may permit real-time transmission (e.g., streaming) of measured climbing parameters. Accordingly, during a climbing competition, for example, involving a number of climbers in a certain area within a national park or at an indoor climbing gym, a number of performance measurement devices may continuously or intermittently report parameters relative to a certain climber. For example, the first climber to reach an altitude corresponding to the top of a rock formation may be immediately reported to a centralized receiver. A centralized receiver may, for example, immediately indicate to a leaderboard, for example, the climber reaching the top of the rock formation. In other instances, if a climber experiences a mishap, such as an acceleration in a negative direction, such an event may be immediately reported to a centralized receiver.

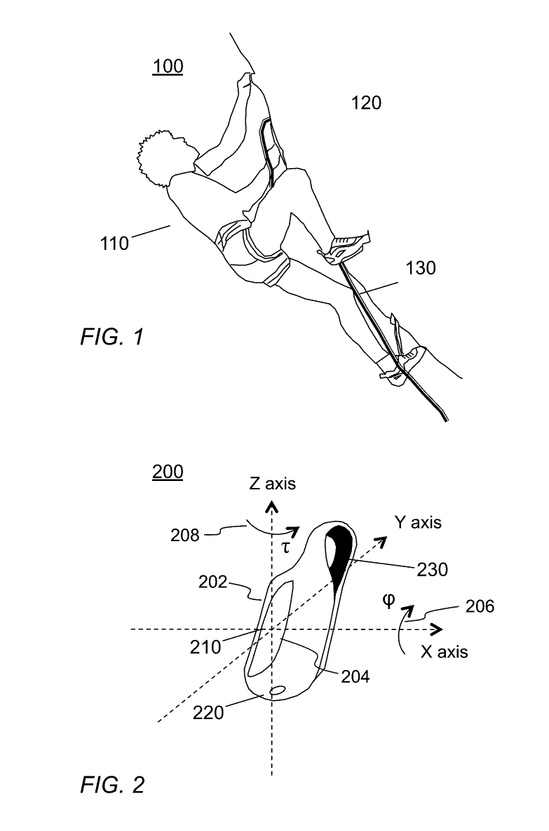

FIG. 1 shows a climber scaling a rock wall according to an embodiment 100. As shown in FIG. 1, climber 110 may utilize climbing rope 130, for example, to scale a steep cliff face, such as cliff face 120, for example. Although not explicitly shown in FIG. 1, a climber may utilize various mechanical climbing aids, such as harnesses, crampons, carabiners, and a wide variety of additional equipment.

FIG. 2 shows a climbing performance measurement device and an example coordinate system 200 according to an embodiment. The coordinate system of FIG. 2 may be used, in whole or in part, to facilitate or support measurement of a climber's performance using an altimeter, output traces from inertial sensors, such as accelerometers, gyroscopes, and so forth. It should be understood, however, that accelerometers, gyroscopes, and altimeters represent merely examples of sensors from which a climber's performance may be measured and classified, and claimed subject matter is not limited in this respect. For example, signals from other types of sensors, (e.g., heart rate sensor, magnetometers, imaging sensors, temperature sensors, just to name a few examples) may be processed for measuring performance of a climber. As illustrated, example coordinate system 200 may comprise, for example, a three-dimensional Cartesian coordinate system, though claimed subject matter is not so limited.

In the illustration of FIG. 2, motion of climbing performance measurement device 202 may represent, for example, acceleration detected or measured, at least in part, with reference to three linear dimensions or axes X, Y, and Z relative to the origin 204 of example coordinate system 200. It should be appreciated that example coordinate system 200 may or may not be aligned with the body of climbing performance measurement device 202. It should also be noted that in certain implementations, a non-Cartesian coordinate system, such as a cylindrical or a spherical coordinate system, or other coordinate system that defines dimensions that are mutually orthogonal may be used.

As also illustrated in FIG. 2, rotational motion of climbing performance measurement device 202, for example, may be detected or measured, at least in part, with reference to one or two dimensions. For example, in one particular implementation, rotational motion of device 202 may be detected or measured in terms of coordinates (φ, τ), where phi (φ) represents pitch or rotation about an X-axis, as illustrated generally by an arrow at 206 and tau (τ) represents roll or rotation about a Z-axis, as illustrated generally by an arrow 208. Accordingly, in an implementation, a three-axis accelerometer (e.g., an accelerometer capable of measuring acceleration in three dimensions) may detect or measure, at least in part, a level of acceleration vibration as well as a change with respect to gravity in roll or in pitch dimensions, for example, thus providing five dimensions of observability (X, Y, Z, φ, τ). It should be understood, however, that these are merely examples of various motions that may be detected or measured with reference to example coordinate system 200, and that claimed subject matter is not limited to these particular motions or to the above-identified coordinate systems.

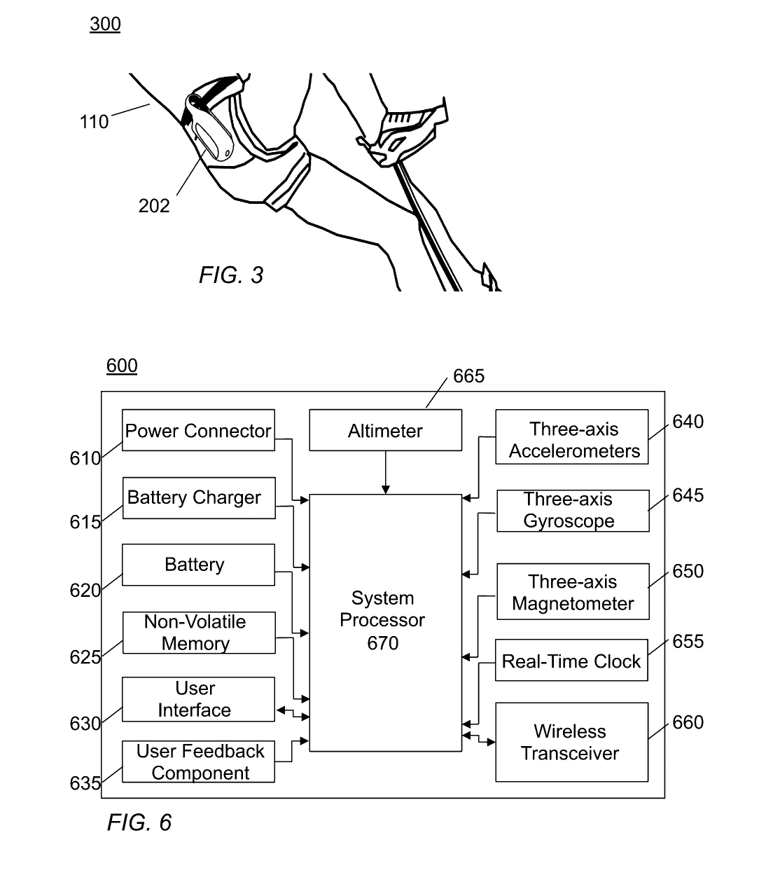

FIG. 3 shows a climbing performance measurement device 202 attached to a climber's midsection according to an embodiment 300. In embodiments, a climbing performance measurement device may be attached to a climber's midsection utilizing, for example, a belt or other type of band that may removably secure the measurement device to the climber's body. By securing the measurement device to the climber's body, spurious accelerations, such as accelerations measured responsive to a climber's hand and arm movements, for example, may be reduced so that the device may measure the movements of the climber's body as a whole. Such measurements may include a climber's acceleration in various axes, and inclination of the climber's body relative to a vertical plane, for example, which may coincide with a plane of a cliff face, as well as side-to-side (e.g., left-to-right) orientation, for example. In embodiments, measurement of inclination of a climber's body with regard to a vertical plane, for example, to provide an approach toward determining a level of difficulty of a particular climbing location.

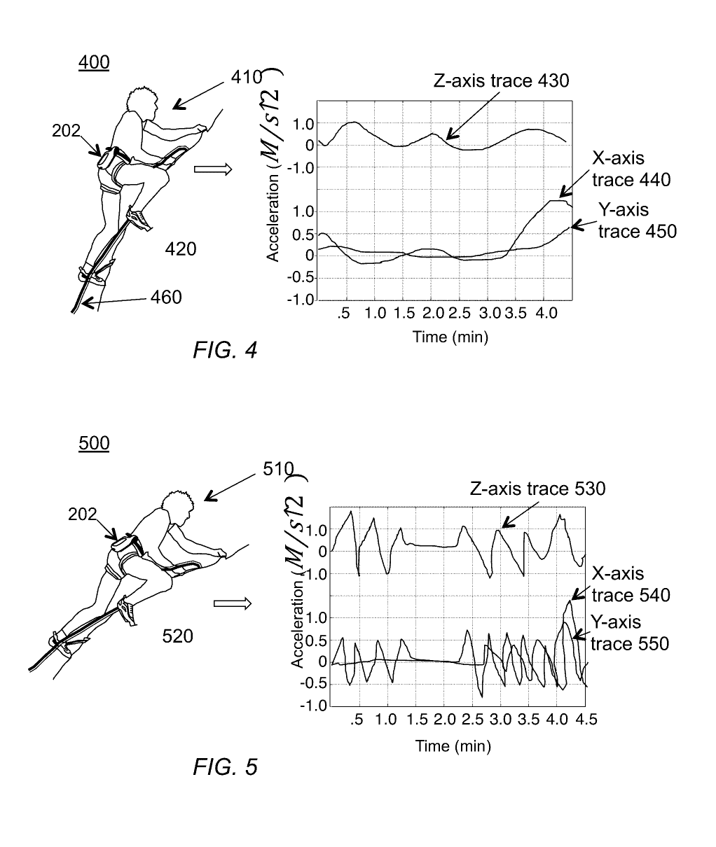

FIG. 4 shows a sample accelerometer output signal trace recorded as a function of time in seconds by a climbing performance measurement device worn by first climber 410 according to an embodiment 400. As shown in FIG. 4, as climber 410 scales a cliff face, such as cliff face 420, output signal traces from a three-axis accelerometer may be recorded and stored in a memory array of a climbing performance measurement device 202. In the embodiment of FIG. 4, measurement device 202 is shown as being affixed to a climber's belt, at approximately waist-level, although claimed subject matter is not limited in this respect. Additionally, although FIG. 4 illustrates output signal traces from a three-axis accelerometer, additional output signal traces, such as signal traces from an altimeter, magnetometer, ambient light sensor, and a variety of additional sensors may be recorded, stored, and utilize to classify a climber's performance, and claimed subject matter is not limited in this respect.

In the example of FIG. 4, a Z-axis trace 430 may indicate relatively smooth movements as climber 410 ascends cliff face 420. As shown, responses to a climber gaining altitude along an upward or +Z direction, Z-axis signal trace 430 may indicate relatively positive accelerations. As climber 410 repositions himself in a horizontal plane (e.g., an XY plane) X-axis signal tracer 440 and Y-axis signal trace may record the climber's accelerations in these directions. As illustrated in FIG. 4, Z-axis trace 430, X-axis trace 440, Y-axis trace 450, are shown as representing relatively smooth movements of climber 410, as a climber ascends cliff face 420. Accordingly, climber 410 may be classified as a “skilled” climber by way of analysis of traces of 430, 440, and 450, for example.

It should be noted that although accelerations are shown in FIG. 4 as approximating values in a range of approximately −1.0 m/s² to +1.0 m/s², such designations are arbitrary and claimed subject matter is not limited in this respect. Rather, claimed subject matter is intended to embrace acceleration ranges smaller than those shown, such as ranges approximating −1.0 m/s² to +1.0 m/s² as well as much greater ranges, such as ranges approximating −5.0 m/s² to +5.0 m/s², ranges approximating −10.0 m/s² to +10.0 m/s², or other meaningful ranges of acceleration, for example. In embodiments, wide ranges of acceleration may be experienced by climber 410 especially during an unfortunate event in which, for example, the climber slips and falls before being caught by climbing rope 460, which may introduce momentary accelerations in a −Z direction which may approach, for example, 9.8 m/s². In embodiments, if climbing rope 460 has lost at least some elasticity, upon catching climber 410, the rope may subject the climber to an abrupt deceleration which may indicate, for example, that climbing 460 is approaching an end to its service life and should be replaced.

FIG. 5 shows a sample accelerometer output signal trace recorded by a climbing performance measurement device worn by a second climber according to an embodiment 500. In the embodiment of FIG. 5, climber 510 may be representative of a climber having less skill than climber 410 of FIG. 5 as may be apparent from analysis of Z-axis trace 530, X axis trace 540, and Y-axis trace 550. As shown by Z-axis trace 530, accelerations in a +Z direction comprise a relatively high frequency components, which may indicate that climber 510 has engaged in much more erratic and/or jerking movements representative of, for example, a novice climber. In addition, traces 530, 540, and 550, which may be indicated by an approximately 30-second rest (e.g., between 1.5 min. and 2.0 min.)

In embodiments, if a climber undergoes a fall, one or more accelerometers may measure an acceleration less than baseline gravity acceleration of, 9.8 m/s² at a time corresponding to, for example, t₁. If the climber subsequently exits freefall, in which acceleration may approach 9.8 m/s², at a time corresponding to, for example t₂, the difference between t₁ and t₂ (e.g., t₂−t₁) may be utilized to estimate a distance that the climber has fallen. Additionally, a freefall exit event, which may correspond to a time t₃ at which the climber is no longer in freefall may be utilized to begin measurement of the forces experienced during an impact phase of a climber's fall. Accordingly, two or more metrics (e.g., distance fallen, the climber's mass, acceleration, the length of rope in the system, and/or forces experienced by the climber at impact) may be utilized to compute a “fall factor” experienced by climber. In embodiments, a “fall factor” may be utilized to specify safety and lifetime durability of climbing ropes. In embodiments, computing a fall factor may include parameters of an individual climber, such as the climber's mass, for example, as well as a length of rope, which may factor into the climber's distance off the ground. Additionally, the fall factor metric may be tracked by a climbing performance measurement device to warn a climber that a rope has reached a critical wear level. Further, in the event that forces experienced during an impact phase of the climber's fall approach a threshold level, a climbing performance measurement device may initiate, without user input, an SOS or other type of distress call to a receiving station such as a mobile telephone, personal laptop computer, or other receiving station.

In addition to measuring and recording output signal traces from a three-axis accelerometer, a climbing performance measurement device may measure and record a “climber orientation metric” as a function of time. As the term is used herein, a “climber orientation metric” may refer to an orientation of the climber in free space. For example, a climber standing upright may characterize a climber orientation metric, as well as a climber angled forward, angled backwards, or angled side-to-side. Quantitatively, a climber orientation metric may comprise, for example, a forward-leaning orientation (e.g., 15 degrees forward) a side-leaning orientation (e.g., 12 degrees to the right or to the left), and a backward-leaning orientation (e.g., 5 degrees backward). In another embodiment, a climber orientation metric may correspond to a current position of the climber's center of mass with respect to a climbing wall, the climber's center mass with respect to gravity, and a climber's present relative position from the floor or base level, from which the climber began the climb. In particular embodiments, maintaining certain orientations may be energy intensive, such as an orientation in which the body is held in a position parallel to the ground.

In an embodiment, measurement of a climber orientation metric may provide an estimate as to an approximate angle of terrain over which the climber is advancing. For example, if a climber is positioned on a steep, overhanging rock, a minimum angle relative to a vertical plane measured, for example, over an interval of approximately 5.0 to 15.0 seconds, just as an example, may correspond to an approximate incline of the overhanging rock. In embodiments, measurement of an orientation metric may be facilitated by an inclinometer to measure a steep and positively-inclined slopes and/or whether an inclined slope angle is backward forward with respect to vertical plane.

Vertical advance of a climber may also be measured and recorded similar to output signals from a three-axis accelerometer and output signal traces from an inclinometer. In embodiments, an altimeter may be utilized to track intermittent individual movements, as well as sustained movements, over a period of, for example, minutes, hours, days and so forth. Output signal traces from an altimeter may be obtained as a climber ascends a cliff, for example, or as a climber descends a cliff, for example, by way of climbing down, hiking, and/or rappelling. Output signal traces from an altimeter may be complemented or supplemented by output signal traces from a three-axis accelerometer to assist in identifying a precise time that an ascent or descent movement has initiated as well as identifying the precise time that an ascent or descent movement has completed. In some embodiments, periods of little vertical advance with movement in an X-Y plane may indicate horizontal advancement and traversal movement. Periods of little advance with little motion, for example, may identify rest periods and/or periods during which a climber may be manipulating climbing gear, for example.

In particular embodiments, combining output signal traces from an altimeter, a three-axis accelerometer, a gyroscope (e.g., to measure rotational movement), and a magnetometer (e.g., to measure heading) may be used by a climbing performance measurement device to characterize type and magnitude of discrete movements performed by climber. Output signal traces from an accelerometer may be utilized to determine the movement impulses, such as pushing with the legs and pulling with the arms, as well as magnitudes of movements. Output signal traces from an altimeter may be utilized to determine vertical advancement of an individual move. Output signal traces from a gyroscope may be utilized to measure rotation to determine or to infer that a climber is making movement types with twisting motions such as a “twist lock” and/or reorienting body portions for particular movements. In some instances, output signal traces from a magnetometer may be utilized to determine or infer rotation or reorientation of a climber's body during a particular movement. Additional indicators derived from output signal traces from various sensors may be utilized in characterizing moves. Such movements may include moments of freefall such as may be experienced during an airborne jumping maneuver.

Accordingly, a difficulty metric of a particular climbing route for a particular climber may be estimated utilizing a complex model incorporating climb length, inclination over time, resting periods, pace of ascent, movement types utilized, and whether the climber has completed a climb without a fall. Such a metric may be recorded and re-analyzed over the course of many climbs to indicate to a climber how the climber is improving.

In addition to identifying and tracking technical climbing activities, output signal traces from various accelerometers, inclinometers, gyroscopes, altimeters, and so forth, may be utilized to identify and/or classify other mountain activities and/or movements. These may include hiking, scrambling, rappelling and other forms of abseiling, ascending, rests, and/or sleep. Activities may be tracked by analyzing an amount and nature of a motion movement in a given time interval as well as a rate of ascent or descent. Movements with distinct step motions and ascent or descent may represent hiking or forward travel. Abseiling may be characterized by rapid descent at a rate less than would be dictated by gravity. Ascending via a rope may exhibit distinct periodic steps in altitude as a climber advances. Scrambling may involve more random and larger step-like motions than hiking. Accordingly, climbing performance measurement devices may assist in creating a substantially complete picture of a mountain trip or expedition for a particular climber.

FIG. 6 shows a schematic diagram of a climbing performance measurement device according to an embodiment 600. Embodiment 600 may be capable of partially or substantially implementing or supporting one or more processes for measuring and/or reporting performance parameters of a climber based, at least in part, on three-dimensional accelerometer 640, three-dimensional gyroscope 640, three-dimensional magnetometer 650, and/or altimeter 665, for example, which may operate under the control of system processor 670. Embodiment 600 may include additional sensors not shown in FIG. 6, and claimed subject matter is not limited to any particular number of sensors or technologies utilized to implement one or more sensors.

Embodiment 600 may comprise wireless transceiver 660, which may permit wireless communication with other climbing performance measurement devices and/or to a centralized receiver. Alternatively, or in addition, wireless transceiver 660, operating under the control of system processor 670, may be communicatively coupled to any number of other devices, mobile or otherwise, via a suitable communications network, such as a cellular telephone network, the Internet, mobile ad-hoc network, wireless sensor network, or the like. For example, the climbing performance measurement device according of embodiment 600 may interact or communicate with one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, the climbing performance measurement device according of embodiment 600 may comprise one or more integrated circuits, circuit boards, or the like. Although not shown, optionally or alternatively, there may be additional devices, mobile or otherwise, communicatively coupled to device 600 to facilitate or otherwise support one or more computing, database access, messaging, machine learning, and related processes. Thus, unless stated otherwise, to simplify discussion, various functionalities, elements, components, etc. are described below with reference to device 600 may also be applicable to other devices not shown.

Nonvolatile memory 625 may represent any suitable or desired information storage medium. For example, nonvolatile memory 625 may include a primary memory, which may comprise, for example, a random access memory, read only memory, etc. While illustrated in this example as being separate from system processor 670, it should be appreciated that all or part of nonvolatile memory 625 may be provided within or otherwise co-located/coupled with system processor 670. Nonvolatile memory 625 may comprise any medium capable of storing or provide access to information, parameters, code, or instructions (e.g., an article of manufacture, etc.) for one or more devices associated with the device of embodiment 600. For example, nonvolatile memory 625 may be provided or accessed by system processor 670. As such, in certain example implementations, the methods or apparatuses may take the form, in whole or part, of a non-transitory computer-readable medium that may include computer-implementable instructions stored thereon, which, if executed by at least one special-purpose processor or other like circuitry, may enable system processor 670 or other like circuitry to perform all or portions of a performance measurement processes, sensor-based or sensor-supported measurements (e.g., acceleration, deceleration, orientation, tilt, rotation, etc.), extraction/computation of features from inertial sensor signals, classifying an a climber's skill level based, at least in part, on measured performance parameters. In certain example implementations, system processor 670 may be capable of performing or supporting other functions, gaming, providing recommendations to climbers for activities that may improve a climber's skill level, recommending climbing outings and/or climbing locations that may require a skill level approximately commensurate with a climber's present skill level or skill level desired any future time, for example.

System processor 670 may be implemented in hardware or a combination of hardware and software. System processor 670 may be representative of one or more circuits capable of performing at least a portion of information computing technique or process. By way of example but not limitation, System processor 670 may include one or more processors, controllers, microprocessors, microcontrollers, application specific integrated circuits, digital signal processors, programmable logic devices, field programmable gate arrays, or the like, or any combination thereof.

Although not shown, it should be noted that the device of embodiment 600 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited. Further, although not shown, the measurement of embodiment 600 may also include a memory or information buffer to collect suitable or desired parameters, such as, for example, accelerometer measurement parameters (e.g., accelerometer output signal traces), as previously mentioned. The device of embodiment 600 may also include power connector 610, for example, to provide power to some or all of the components or circuitry. Power connector 610 may provide and interface to battery charger 615, battery 620, as well as system processor 670. It should be appreciated that a power source may be integrated into (e.g., built-in, etc.) or otherwise supported by (e.g., stand-alone, etc.) the device of embodiment 600.

Embodiment 600 may additionally comprise user interface 630 (e.g., display, touch screen, keypad, buttons, knobs, microphone, speaker, trackball, data port, etc.) to receive user input, facilitate, or support sensor-related signal measurements, or to provide parameters to a user. The device of embodiment 600 may further include a communication utilizing user feedback component 635, which may include a vibration motor, for example, which may operate to provide events and status to a climber.

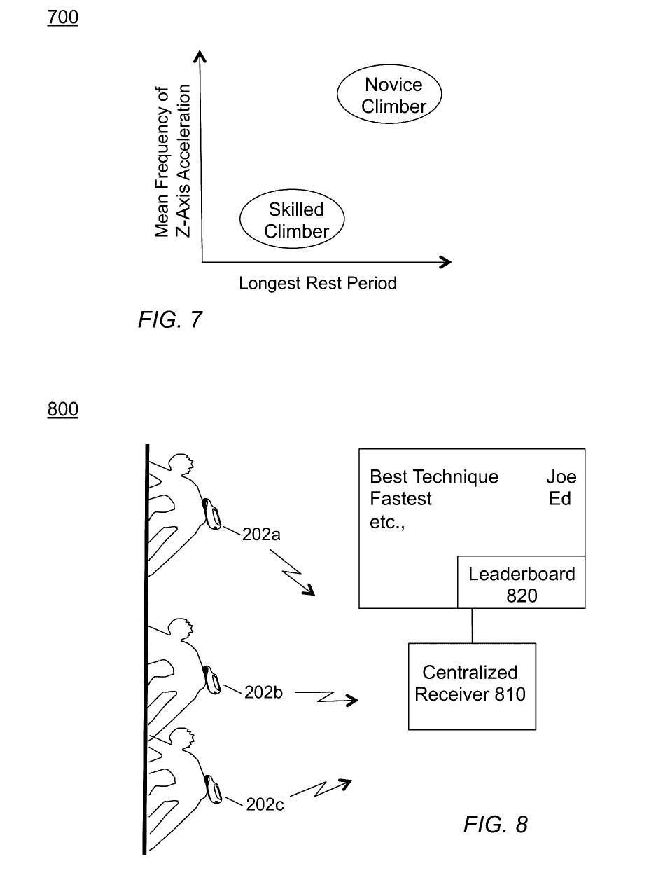

FIG. 7 shows a simplified plot of parameters recorded from a climbing performance measurement device and climber's potential skill classification according to an embodiment 700. As indicated in FIG. 7, a system processor, such as system processor 670, of a climbing performance measurement device may operate to classify a climber as a “novice” climber based, at least in part, on a mean frequency of Z-axis acceleration. Thus, as described with reference to FIGS. 4 and 5, if a climber's movements exhibit higher-frequency content, which may indicate erratic or jerking movements, the climber's skill level may be classified accordingly. In addition, a climber who appears to require longer rest periods, also as described with reference to FIGS. 4 and 5, for example, may also be classified as a “novice” climber.

FIG. 8 shows an indoor climbing competition along with a leaderboard identifying climbers according to an embodiment. As shown in FIG. 8, a group of climbers may be engaged in climbing simulated cliff face 810. Although three climbers are shown in FIG. 8, in embodiments, virtually any number of climbers may be engaged in climbing, for example, simulated cliff face 810. Climbers shown in FIG. 8 may each be equipped with a climbing performance monitoring devices as indicated by 202a, 202b, and 202c. In embodiments, each of devices 202a, 202b, and 202c may wirelessly transmit a real time “stream” comprising output signal traces from a three-axis accelerometer, a three-axis gyroscope, a three-axis magnetometer, and altimeters, along with other sensors of devices 202a, 202b, and 202c, for example, to centralize receiver 810.

Centralized receiver 810 may comprise a processor and interface circuitry to provide electronic leaderboard 820 with names or other identifiers that correspond to the climber with, for example, the “best technique” responsive to analysis of output signal traces from various sensors within each of devices 202a, 202b, and 202c. Thus, as a climbing competition progresses, and as participants complete climbing tasks and/or score points, for example, leaderboard 820 may be updated so as to permit real-time display of the climber currently leading in one or more climbing performance categories.

In a particular embodiment, climbers shown in FIG. 8 may train as a team, for example, utilizing centralized receiver 810, for example. In such an embodiment, centralized receiver 810 may include processing and software resources to integrate a substantially complete picture of a climbing event. Processing and software resources of centralized receiver 810 may allow a determination of when two or more climbers are performing the same activity, for example, or when climbers are trading off roles. Such integrations and/or analysis may permit a pair or a team of climbers to evaluate performance and efficiency at tasks such as transferring gear, rearranging robes and other rigging, and when the team of two climbers, for example, swaps belay and climbing responsibilities. Accordingly, by way of centralized receiver 810, a climber or team of climbers may review their performance at substantially all aspects of the sport of climbing including technical climbing performance, teamwork, and/or logistics.

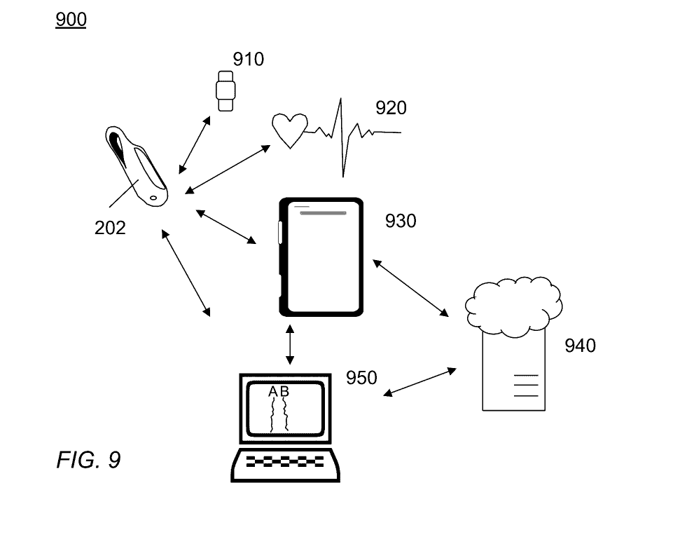

FIG. 9 shows a climbing performance measurement device forming a part of a distributed computing network according to an embodiment 900. In an embodiment, a wireless transceiver, such as wireless transceiver 660 of FIG. 6, for example, may permit a climbing performance monitoring device to report to a tertiary display, such as, for example, wrist-worn computer 910 to permit display of real-time tracking parameters to a user. For example, statistics such as vertical gain and pace may inform a climber of whether the climber is on schedule and how much terrain still must be covered in a given climbing period. Thus, in the event that a climbing site is experiencing a sudden weather change, a climber may remain informed that he or she must accommodate and/or adjust to, for example, inclement weather while completing a stage of a climb. In a training environment, a tertiary display may provide real-time tracking of progress towards a goal, such as a number of vertical feet climbed within a period of time, for example. A tertiary display may be particularly useful when a climber is rappelling, for example, to immediately notify the climber that a distance descended is approaching a rope length.

In embodiments, a climbing performance measurement device may be synchronized with, for example, wrist-worn computer 910 to permit synchronizing of heartrate, such as heart rate measured by wrist-worn computer 910, with climbing events. For example, in the event that output signal traces from one or more accelerometers indicate that a climber has fallen some distance, heart rate, as measured by wrist-worn computer 910, may provide an indication of a level of stress experienced by the climber in response to the fall. In another example, if a measured heart rate indicates that a climber who appears to be experiencing undue stress, perhaps by measuring and accelerated heart rate, the climber may benefit from a notification that he or she may wish to rest, obtain refreshments, or perhaps continue the climb at a slower pace. In embodiments, connectivity among wrist-worn computer 910, GPS-equipped device 930, cloud-computing database, and computer 950 may occur utilizing a wireless communications protocol such as Bluetooth. In another embodiment, a climbing performance measurement device 202 may obtain a climber's heart rate utilizing a chest strap or other type of sensor, such as sensor 920.

In embodiments, a climbing performance measurement device may occasionally receive absolute position parameters, from a GPS-equipped device 930, which may enhance accuracy of an air pressure sensor of, for example, altimeter 665 of FIG. 6. In embodiments, such absolute position parameters may be utilized to identify a location in which a climber is practicing, such as at a particular gym, climbing site, or cliff face. Absolute position parameters may be utilized in conjunction with specific movements, difficulty estimation models, and a known database of climbs to indicate the specific route that a climber is climbing.

In embodiments, a climbing performance measurement device may utilize a wireless transceiver, such as wireless transceiver 660 of FIG. 6, for example, or may utilize a wired connection, for example, to display a differential comparison attempts at an identical climbing site utilizing, for example, laptop, desktop, or handheld computer 950. Additionally, parameters from other climbers who have attempted a particular climb may be accessed to display climbing parameters from one or more other climbers, for example, via a cloud-computing database 940. In some instances, stored insights from a database, which may be referred to as “beta” may provide a climber with particular insight as to specific moves to utilize in a particularly difficult section of the climb. Other insights may include resting points discovered by other climbers during a particular climb, for example.

In other embodiments, cloud-computing database 940 may be accessed to provide suggestions of climbing adventures, and to alert the climber of timely, spatially relevant parameters, such as if the climber is nearing an often-used anchoring position at a climbing site, or of difficult-to-read foot work or a juncture along a climbing route. If the climber is hiking to the base of the cliff, the climbing performance measurement device may inform the climber of a fork in the path or, for example, that the climber is approaching a destination.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a system processor may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine-readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or parameters as expressed by a particular state of the storage media. For example, an electronic signal representative of data or parameters may be “stored” in a portion of the storage media (e.g., memory) by affecting or changing the state of such portions of the storage media to represent data or parameters as binary information (e.g., ones and zeros). As such, in a particular implementation, such a change of state of the portion of the storage media to store a signal representative of data or parameters constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a measurement device may be capable of communicating with one or more other devices via wireless transmission or receipt of parameters over various communications networks using one or more wireless communication techniques. Here, for example, wireless communication techniques may be implemented using a wireless wide area network (WWAN), a wireless local area network (WLAN),a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (WCDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3^{rd} Generation Partnership Project” (3GPP). Cdma2000 is described in documents from a consortium named “3rd Generation Partnership Project 2”(3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

It has proven convenient at times, principally for reasons of common usage, to refer to such signals as bits, parameters, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. However, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

1. An apparatus comprising:
an altimeter to measure a vertical distance traversed by a climber;
an inclinometer to measure an angle of incline of at least a portion of the climber's body during one or more portions of the climber's traversal of the vertical distance; and
a memory to record measurements of the vertical distance and the angle of incline of the at least a portion of the climber's body.

2. The apparatus of claim 1, further comprising a transmitter to wirelessly communicate measurements of the vertical distance and the angle of incline in a substantially real-time manner.

3. The apparatus of claim 1, further comprising:
one or more accelerometers to measure accelerations of the climber's body during the one or more portions of the climber's traversal.

4. The apparatus of claim 3, further comprising:
one or more processors to implement an optimization filter, the optimization filter to determine the vertical distance climbed based, at least in part, on output signals from the altimeter and output signals from the one or more accelerometers.

5. The apparatus of claim 4, wherein the optimization filter comprises a Kalman filter.

6. The apparatus of claim 4, wherein the one or more processors are additionally to implement a classifier to determine a skill category based, at least in part, on one or more output signals from the altimeter, one or more output signals from the inclinometer, and one or more output signals from the one or more accelerometers.

7. The apparatus of claim 4, wherein the one or more processors are additionally to provide at least one suggestion, the at least one suggestion to refer to a climbing location or climbing activity based, at least in part, on the climber's skill level estimated by the one or more processors.

8. The apparatus of claim 4, wherein the one or more processors are additionally to provide at least one suggestion of a climbing skill in need of improvement.

9. (canceled)

10. The apparatus of claim 8, further comprising mounting provisions to maintain orientation of the apparatus in correspondence with orientation of the climber's waist area of the climber's midsection.

11. An article comprising:
a storage medium comprising machine-readable instructions stored thereon which are executable by one or more processors of a computer to:
initiate determination of a vertical distance traversed by a climber;
initiate measurement of an incline of at least a portion of the climber's body during one or more portions of the climber's traversal of the vertical distance climbed; and
initiate storage, in a memory array, of recorded measurements of the vertical distance and angle of incline of the at least a portion of the climber's body.

12-21. (canceled)

22. The apparatus of claim 1, further comprising mounting provisions to couple the apparatus to an area proximate with a midsection area of the climber's body.

23. The article of claim 11, wherein the storage medium comprising computer-readable instructions stored thereon which are executable by the one or more processors of the computer are additionally to:
initiate recording of output signal traces from one or more three-axis accelerometers, a gyroscope, a magnetometer, or any combination thereof.

24. The article of claim 23, wherein the storage medium comprising computer-readable instructions stored thereon which are executable by the one or more processors of the computer are additionally to:
initiate optimal filtering of output signal traces from an altimeter combined with the output signal traces of one or more accelerometers to arrive at the vertical distance traversed by the climber.

25. The article of claim 11, wherein the storage medium comprising computer-readable instructions stored thereon which are executable by the one or more processors of the computer are additionally to:
wirelessly transmit parameters to a centralized receiver based, at least in part, on output signal traces from one or more accelerometers, one or more inclinometers, one or more altimeters, one or more magnetometers, one or more gyroscopes, or any combination thereof.

26. The article of claim 11, wherein the storage medium comprising computer-readable instructions stored thereon which are executable by the one or more processors of the computer are additionally to:
initiate providing a suggestion to a climber as to a climbing skill in need of improvement.

27. The article of claim 11, wherein the storage medium comprising computer-readable instructions stored thereon which are executable by the one or more processors of the computer are additionally to:
classify a climber's performance based, at least in part, on output signal traces of one or more accelerometers.

28. An apparatus comprising:
means for measuring vertical distance traversed by climber;
means for measuring inclination of at least a portion of the climber's body during one or more portions of the climber's traversal of the vertical distance climbed; and
means for recording measurements of the vertical distance and an angle of incline of the at least a portion of the climber's body.

29. The apparatus of claim 28, further comprising:
means for reporting output signal traces corresponding to measurements of vertical distance traversed by a climber.

30. The apparatus of claim 28, further comprising:
means for classifying a climber's skill level.

31. The apparatus of claim 28, further comprising:
means for suggesting an activity to improve a climber's skill level.
